(19) United States
(12) Patent Application Publication
(10) Pub. No.: US 2011/0225152 A1
(43) Pub. Date: Sep. 15, 2011

(54) CONSTRUCTING A SEARCH-RESULT CAPTION

(75) Inventors: SCOTT BEAUDREAU, Redmond, WA (US); Gayathri Venkataraman, Redmond, WA (US); Ajay Nair, Kirkland, WA (US); Alnur Ali, Kirkland, WA (US); Ian Johnson, Sammamish, WA (US); Daniel Marantz, Bellevue, WA (US); Tim Hoad, Redmond, WA (US); Rekha Seshadrinathan, Bellevue, WA (US); Ping Yin, Beijing (CN); Minnie Yan, Beijing (CN); Toan Huynh, Redmond, WA (US); Song Zhou, Redmond, WA (US); Ramki Natarajan, San Jose, CA (US)

(73) Assignee: MICROSOFT CORPORATION, REDMOND, WA (US)

(21) Appl. No.: 12/724,126

(22) Filed: Mar. 15, 2010

(51) Int. Cl. G06F 17/30

(52) U.S. Cl. 707/728; 707/769; 707/E17.014; 707/740; 707/E17.09

(57) ABSTRACT

The present invention is related to constructing a search-result caption that represents content of a search result (e.g., webpage). Information that is extracted from the webpage and/or other webpages is categorized and ranked based on a perceived relevance to a user context. Extracted information is then compared for inclusion in the search-result caption in order to provide a caption that accurately reflects content of the webpage and that is relevant to a context of the user

### BACKGROUND

Internet users commonly submit search queries to locate information related to a topic of interest. Usually, search results are identified in response to such search queries. To summarize each search result (e.g., webpage), often a brief description of the search result is provided, and the brief description generally includes a title, a body of text, and a web address. The brief description is typically generated from a limited set of information. Technology that expands the set of information from which the brief description is generated would be useful, as well as technology that configures the brief description to be relevant to a user context.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed-description section below. This summary is not intended to identify key features or essential features of the claimed subject matter, nor is it intended to be used as an aid in isolation to determine the scope of the claimed subject matter.

Embodiments of the present invention are directed to constructing a search-result caption that represents content of a webpage. In one embodiment, unstructured information of the webpage is used to construct the search-result caption. In a further embodiment, information related to one or more other webpages, a user, and a client device might also be used to construct the search-result caption. A search-result caption constructed using an embodiment of the present invention might enhance a user-search experience in various ways, such as by providing a caption that accurately reflects content of the webpage and that is relevant to a context of the user.

### BRIEF DESCRIPTION OF THE DRAWINGS

Illustrative embodiments of the present invention are described in detail below with reference to the attached drawing figures, wherein:

FIG. 1 is a block diagram depicting an exemplary computing device suitable for use in accordance with embodiments of the invention;

FIGS. 2a and 2b are block diagrams of an exemplary operating environment in accordance with an embodiment of the present invention;

FIG. 3 is an exemplary screen shot in accordance with an embodiment of the present invention;

FIG. 4 depicts exemplary caption templates in accordance with an embodiment of the present invention; and

FIGS. 5 and 6 are flow diagrams of exemplary methods in accordance with an embodiment of the present invention.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly stated.

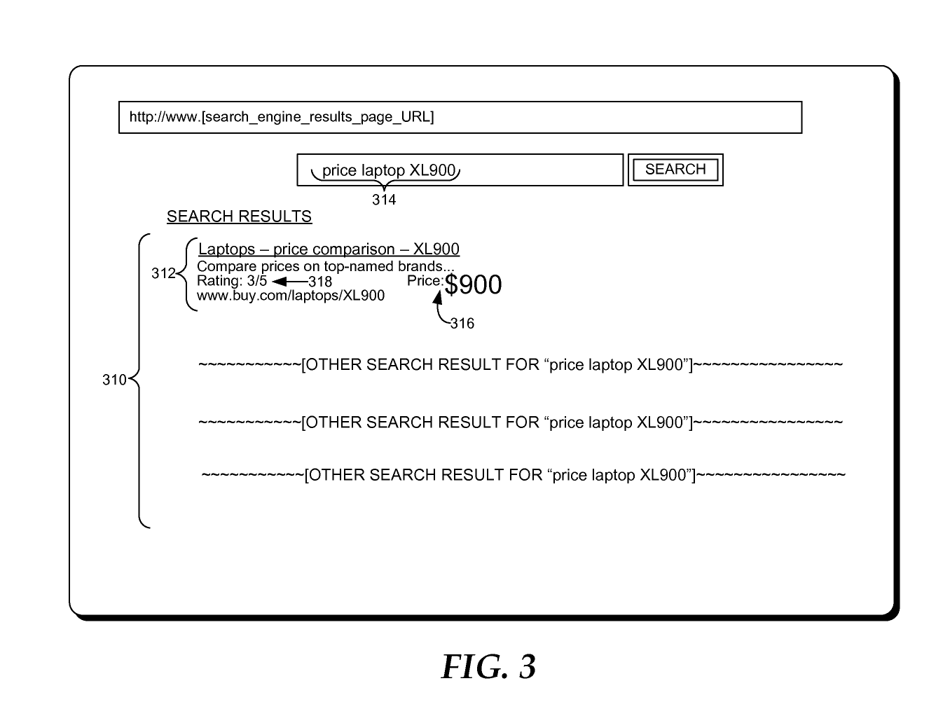

Generally, embodiments of the present invention are directed to constructing a search-result caption that represents content of a webpage. As used herein, the term “search-result caption” refers to an arranged set of information that is associated with a specified search result (e.g., webpage). The set of information might be presented in various formats, one of which includes a title, a body of text, and a web address of the search result. While a search-result caption often functions to summarize or represent content that is included in a search result, examples of other functions include describing the content and providing a copy of content. Referring briefly to FIG. 3, an exemplary search-result caption 312 is depicted that is included within a set of search results 310, which are returned in response to a search query 314. An embodiment of the present invention aggregates information (e.g., 316 and 318) to be included in search-result caption 312 and customizes search-result caption 312 based on the search query 314 and/or capabilities of a requesting device (e.g., client).

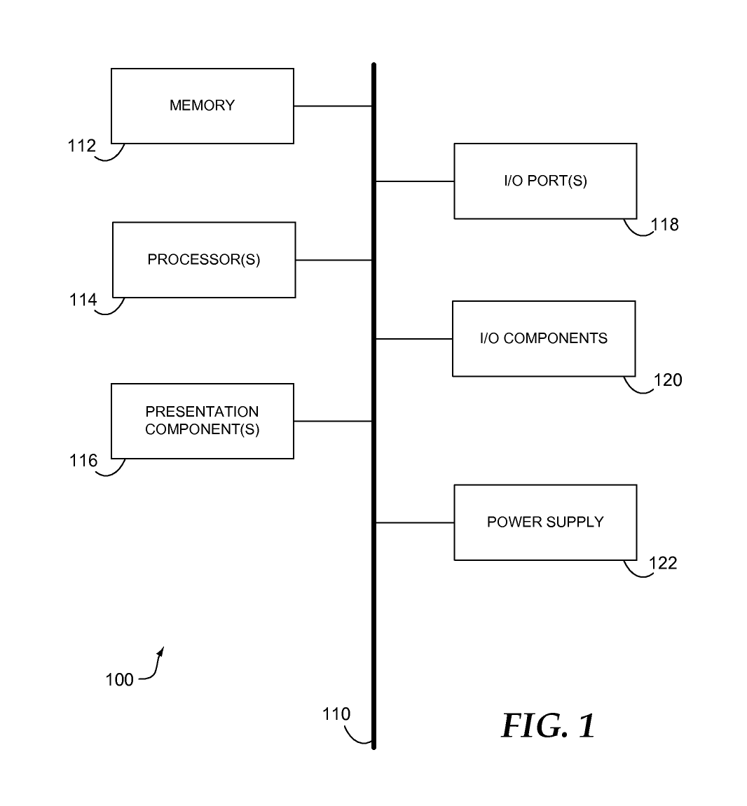

Having briefly described embodiments of the present invention, now described is FIG. 1 in which an exemplary operating environment for implementing embodiments of the present invention is shown and designated generally as computing device 100. Computing device 100 is but one example of a suitable computing environment and is not intended to suggest any limitation as to the scope of use or functionality of invention embodiments. Neither should the computing device 100 be interpreted as having any dependency or requirement relating to any one or combination of components illustrated.

Embodiments of the invention might be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention might be practiced in a variety of system configurations, including handheld devices, consumer electronics, general-purpose computers, more specialty computing devices, etc. Embodiments of the invention might also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and a power supply 122. Bus 110 represents what might be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. By way of example, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors 114 that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

Embodiments of the present invention might be embodied as, among other things: a method, system, or set of instructions embodied on one or more computer-readable media. Computer-readable media include both volatile and nonvolatile media, removable and nonremovable media, and contemplates media readable by a database, a switch, and various other network devices. By way of example, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

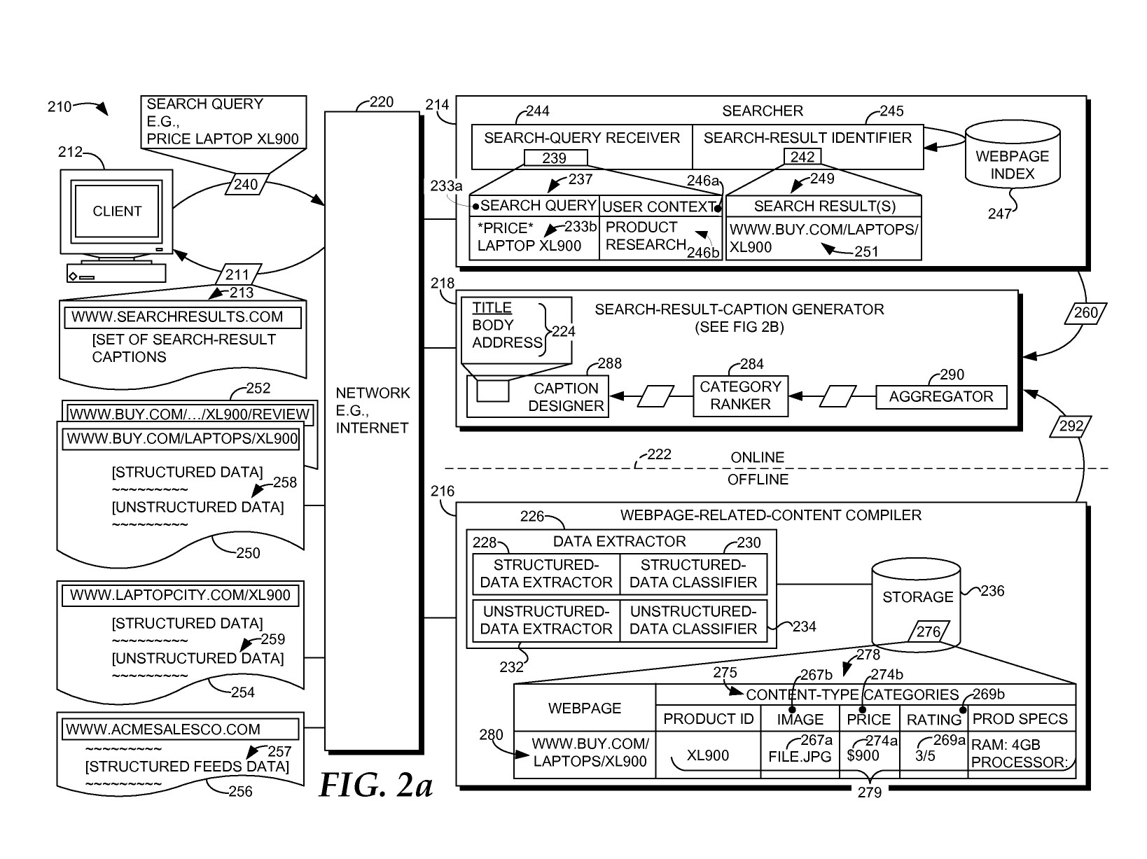

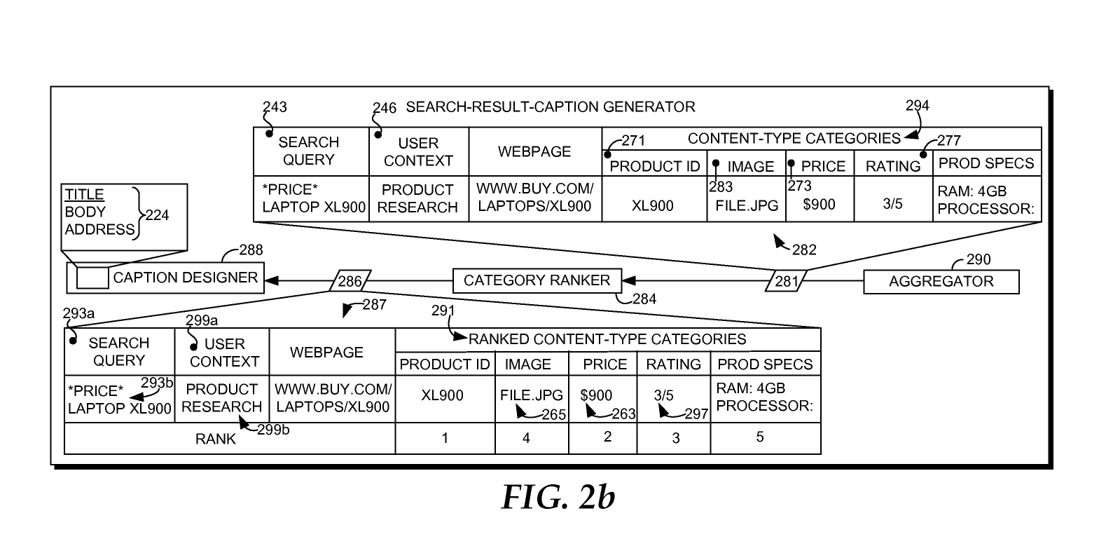

Referring to FIG. 2a, a computing environment that includes networked components is depicted and is identified generally by reference numeral 210. Computing environment 210 includes a client 212, a searcher 214, a webpage-related-content compiler 216, a search-result-caption generator 218, and webpages 250, 252, 254, and 256. The various components of computing environment 210 communicate, such as by way of network 220. Line 222 of FIG. 2a suggests that in an embodiment of the present invention certain functionality of computing environment 210 is carried out online (e.g., receiving a search query and providing search results), while other functionality is carried out offline (e.g., extracting information to be included in a search-result caption). FIG. 2a depicts an exemplary embodiment that will be described in more detail below. Generally, FIG. 2a depicts that a search query 240 (e.g., “Price Laptop XL900”) is submitted from client 212 to searcher 214. Search result(s) 242 are identified, one of which includes “www.buy.com/laptops/XL900” 251. A search-result caption 224, which describes one of the search results, is generated by search-result-caption generator 218 using information retrieved from webpage-related-content compiler 216. For exemplary purposes, FIGS. 2a and 2b are described such that search-result caption 224 represents content of webpage 250, which is located at “www.buy.com/laptop/XL900.”

In an embodiment of the present invention, various tasks are performed in preparation of constructing search-result caption 224. For example, information is compiled that is usable to compose search-result caption 224. Information that is usable to compose search-result caption 224 might originate from various sources, such as webpage 250, webpage 252 (which is part of the same website as webpage 250), and webpages 254 and 256 that are part of different websites than webpages 250 and 252. FIG. 2a depicts that webpage-related-content compiler 216 includes a data extractor 226, which assists with compilation of information. Data extractor 226 includes a structured-data extractor 228, a structured-data classifier 230, an unstructured-data extractor 232, and an unstructured-data classifier 234. Moreover, webpage-related-content compiler 216 includes storage 236, which is usable to store data once it has been extracted. For example, once data has been extracted from webpages 250, 252, 254, and 256, it is maintained in storage 236.

In an embodiment of the present invention, unstructured data is extracted from webpage 250, webpage 252, webpage 254, or a combination thereof. Furthermore, extracted unstructured data is classified into one or more categories of information, such as those categories listed under content-type categories 275. In one embodiment, unstructured-data extractor 232 functions to extract information, and unstructured-data classifier 234 functions to classify information. While unstructured-data extractor 232 and unstructured-data classifier 234 are depicted as separate components for illustrative purposes, in another embodiment they are combined into a single component that both extracts and classifies. Furthermore, categories listed under content-type categories 275 might depend on a type of website. For example, if a webpage is part of a company's website, categories listed under content-type categories 275 might be different from those depicted in FIG. 2a, in which case exemplary categories might include a stock price, contact information, a map, etc. Alternatively, if a website operates to facilitate multimedia (e.g., video and/or music) sharing, content-type categories 275 might include playtime length, file creation date, file size, rating, etc.

In one embodiment, unstructured data 258 of webpage 250 (e.g., text of a cached page) is extracted by unstructured-data extractor 232 when compiling information that relates to webpage 250. For example, it might be desirable to identify certain text of unstructured data 258 that would be particularly informative to a user that is determining whether to select webpage 250 from a list of search results. That is, often readily available structured text is provided, such as by a designer of webpage 250, to be used in a search-result caption as a representation of content of webpage 250. However, the readily available structured text might not provide an accurate representation of webpage 250 and/or might not provide information that is relevant to a search query. As such, by extracting and classifying other text of unstructured data 258, data extractor 226 expands the set of information that is usable to construct search-result caption 224. With an expanded set of information, search-result caption 224 might include a more accurate representation of content of webpage 250 that is helpful to a user.

In one embodiment, unstructured-data extractor 232 includes a customized crawler that is programmed to recognize certain types of information. Once unstructured data 258 is extracted from webpage 250, it is classified by unstructured-data classifier 234 based on how unstructured data 258 is interpreted. For example, unstructured data 258 might be interpreted as a dollar amount based on formatting (e.g., USD symbol and numerals); in which case a dollar-amount input 274a is stored in storage 236 under a price category 274b. Extracted and categorized information is maintained in storage 236.

Unstructured-data extractor 232 might be programmed using various other techniques. For example, in one technique a set of webpages with sufficiently similar document structures are identified, such as by identifying a common URL pattern or common snippet of HTML content. Often such sites are constructed using same or similar server software, which once identified, is leveraged to identify patterns. Metadata of the set of webpages is identified and unstructured-data extractor 232 is programmed specifically for webpages having the sufficiently similar document structure. For example, schemas of the unstructured-data extractor 232 might map to the consistently patterned unstructured data. As such, the unstructured data of subsequently analyzed webpages, which have the sufficiently similar structure, is extracted and categorized.

In another embodiment, unstructured-data extractor 232 extracts unstructured data (not depicted) from webpage 252, which belongs to the same website (www.buy.com) as webpage 250. Unstructured-data extractor 232 might attempt to locate unstructured data of webpage 252 that is related to content on webpage 250. For example, if webpage 250 includes content that describes a particular model (e.g., XL900) of laptop, webpage 252 (www.buy.com/ . . . /XL900/reviews) might include within unstructured data a user rating of that particular model, such that a user-rating input 269a is extracted and stored in storage 236 under a rating category 269b. Extracted unstructured data of webpage 252 is classified into content-type categories 275, such as by using a customized crawler or other component that is programmed to recognize certain types of content. Extracted unstructured data of webpage 252 that is classified might then be used to construct search-result caption 224.

In another embodiment, unstructured-data extractor 232 extracts unstructured data 259 from webpage 254, which belongs to a different website from webpage 250. Unstructured-data extractor 232 might attempt to locate within webpage 254, unstructured data 259 that is related to content on webpage 250. For example, if webpage 250 includes content that describes a particular model (e.g., XL900) of laptop, webpage 254 (www.laptopcity.com/XL900) might include within unstructured data 259 an image of the particular model of laptop, such that image-date input 267a (e.g., image file) is extracted and stored in storage 236 under an image category 267b. Extracted unstructured data of webpage 254 is classified into content-type categories 275, such as by using a customized crawler or other component that is programmed to recognize certain types of content. Extracted unstructured data of webpage 254 that is classified might then be used to construct search-result caption 224.

In a further embodiment of the present invention, structured data is extracted from webpage 250, webpage 252, webpage 254, webpage 256, or a combination thereof. Furthermore, extracted structured data is classified, into one or more categories of information, such as content-type categories 275. In one embodiment, structured-data extractor 228 functions to extract information, and structured-data classifier 230 functions to classify information. While structured-data extractor 228 and unstructured-data classifier 230 are depicted as separate components for illustrative purposes, in another embodiment they might be combined into a single component that both extracts and classifies. Because structured data is often organized in a manner that makes classification readily determinable, such organization is leveraged by structured-data classifier 230 to classify extracted structured data into content-type categories 275.

In one embodiment of the present invention, structured-data extractor 228 extracts structured data 257 from webpage 256, which belongs to a different website from webpage 250. Structured-data extractor 228 might attempt to locate within webpage 256 structured data 257 that is related to content on webpage 250. In an alternative embodiment, structured data 257 includes structured feeds data that is communicated by webpage 256, e.g., structured feeds data might be communicated from webpage 256 to structured-data extractor 228. Examples of structured feeds data include news feeds, blog feeds, and product feeds. In the exemplary embodiment of FIG. 2a, webpage 250 might include content that describes a particular model (e.g., XL900) of laptop and webpage 256 (www.acmesalesco.com) might include within structured data 257 pricing information or rating information related to the particular model, such that dollar-amount input 274a or rating input 269a is received, dynamically updated, and stored in storage 236. Structured data 257 of webpage 256 that is categorized might then be used to construct search-result caption 224.

In a further embodiment of the present invention, when information is being compiled for a given webpage (e.g., webpage 250), information sources (e.g., webpages 250, 252, 254, and 256) are referenced in a prescribed order. That is, a given webpage (e.g., webpage 250) might be assigned a set of desired content-type categories (e.g., 275) based on a nature of the webpage. For example, a webpage directed to selling and/or reviewing a product might be assigned those content-type categories 275 depicted in FIG. 2a, whereas a social-networking webpage might be assigned an alternative set of desired content-type categories (not shown) that include: name, occupation, location, status, and profile link(s). When compiling information related to a given webpage under each of the desired content-type categories, information sources might be searched in a prescribed order. In one embodiment, the prescribed order includes searching (e.g., crawling) the given webpage first. If all of the desired content-type categories are not filled by using information extracted from the given webpage, another webpage of the same website as the given webpage might be searched second, followed by webpages of other websites that are different from the website of the given webpage.

In a further embodiment of the present information, once information has been extracted, the information is scored to suggest a quality level of the information. That is, if some webpage-related information is of a better quality than other webpage-related information, it might be desirable to select the better quality information. Accordingly, a quality score that is assigned to an item of information is usable by other components of computing environment (e.g., search-result-caption generator 218) to assess a quality level of webpage-related information.

As previously indicated, once data has been extracted it might be stored in storage 236. Storage 236 includes data 276 that for illustrative purposes is depicted in an exploded view 278. Exploded view 278 includes information 279 that has been extracted or received, such as from webpages 250, 252, 254, and 256, and that relates to content of webpage 250 that is identified by web address 280. In FIG. 2a information 279 has been classified into various categories of information, such as when information 279 is classified by structured-data classifier 230 or unstructured-data classifier 234. Exemplary categories, which are listed under content-type categories 275, include “Product ID,” “Image,” “Price,” “Rating,” and “Prod Spec.” However, as previously indicated, in an embodiment of the present invention, categories listed under content-type categories 275 might depend on a nature of webpage 280 (e.g., webpage of a company's website or a video-sharing website). From storage 236, data 276 is retrievable to be included in search-result caption 224. For example, information 292 is provided to search-result-caption generator 218.

Once information related to a webpage has been compiled (i.e., extracted/received and classified), the information is available to be used to construct a search-result caption in response to a search query. As previously indicated, search query 240 that is sent by client 212 is received by searcher 214, such as by using a search-query receiver 244. Reference numeral 239 represents information that is shown in an exploded view 237 to depict a search query 233a (e.g., “*price*laptop XL900” 233b) that was received by search-query receiver 244 and that corresponds to search query 240 that was sent by client 212.

In one embodiment, search-query receiver 244 determines a user context 246a (e.g., product research 246b). User context 246a might describe various aspects of a user or client, such as an objective of a user (e.g., commerce, research, person/business locator, etc.) when submitting a query and capabilities of client 212 (e.g., screen real estate) that are available to present a search-result caption. In embodiments of the present invention, user context 246a is utilized to predict categories of information (e.g., information ultimately selected from content-type categories 275) that might be most relevant to a user that submits search query 239, such that the predicted categories of information are included in a search-result caption provided in response to the search query 239.

Search-query receiver 244 might assess various factors related to user context 246a. For example, the text of search query 233a alone might infer a certain user context. As indicated in FIG. 2a, user context 246a, which includes “product research” 446b, has been assigned to “Price Laptop XL900” 233b, suggesting that user context 246a might be based on the text “price” and “laptop XL900.” Moreover, other factors considered by search-query receiver 244 might include a browsing history of client 212, time of day, purchase history of client 212, calendar of dates stored on client 212, etc. In one embodiment, a user indicates a user context by expressly navigating through a vertical arrangement of information (e.g., shopping, travel, etc.).

In addition to “product research,” several alternative user objectives that are relevant to user context 246a might be assigned to a search query and each alternative user objective might evoke a different set of predicted information categories. Other exemplary user objectives include person identification, in which predicted information categories might include contact information, social-network profiles, images, and occupation; multimedia search, in which predicted information categories might include title, lyrics, length, file size, and user rating; place locator, in which predicted information categories might include a map location; entity identifier, in which predicted information categories might include business hours and contact information; company review, in which predicted information categories might include stock information and recent news; reading-literature search, in which predicted information categories might include author, publication date, and user rating; research papers, in which predicted information categories might include author and publication date; reference resources (e.g., online dictionary), in which predicted information categories might include a publication date and an entry summary; blogs, in which predicted information categories might include a recent post; and technical-data search, in which predicted information categories might include code snippets and file size.

In one embodiment, search-query receiver 244 might identify more than one user objective that applies to a given search query. Accordingly, search-query receiver 244 might assign a confidence measure to each of the more than one user objectives, such that more than one user objective is assigned to a search query. Such a confidence score might suggest a degree to which the user context is deemed to be accurate. In an alternative embodiment, search-query receiver 244 might not identify any user context, in which case a default user context is assigned to the search query.

In another embodiment, search-query receiver 244 might identify trigger words that are included within search query 233a, such that an identified trigger word provides particular insight into information that would be relevant to search query 233a. For example, search query 233b is marked (i.e., with asterisks) such that “*price*” has been identified as a trigger word, thereby indicating to other components of operating environment 210 that price-related information is likely to be relevant to search query 233a.

Based on the foregoing, several different factors might influence user context 246a. These different factors might include a user objective (e.g., buying or reviewing a product), trigger words, client 212 capabilities (e.g., screen real estate and other browser characteristics), browsing history, purchase history, language, date, time of day, upcoming appointments of a user, known other scheduled events (e.g., public events), user demographics, and user-specified preferences (e.g., more results with less detail). Other factors might include inferences that are drawn from a click graph, current search-engine vertical (e.g., web, images, news, etc.), or domain-level task pages (e.g., investors data, contact, etc.). In one embodiment, these factors might be weighted such that certain factors influence a user context more than others. For example, a user objective and trigger words might be weighted to have a greater influence on user context than the time of day. The above are meant to be examples to illustrate that user context might factor in several different considerations when determining how to evaluate a search query.

A search-result identifier 245 functions to reference a webpage index 247 in order to identify search results 242 relevant to search query 233a. Search results 242 are shown in exploded view 249 for illustrative purposes. Exploded view 249 depicts an exemplary search result, which includes “www.buy.laptops/XL900” 251 that was identified by search-result identifier in response to search query 233a. Although search-query receiver 244 and search-result identifier 245 are depicted as individual components for illustrative purposes, search-query receiver 244 and search-result identifier 245 might be combined into a single component that receives search queries, determines user contexts, and identifies search results.

In an embodiment of the present invention, search-result-caption generator 218 receives information 260 from searcher 214. For example, information 260 might indicate a user context (e.g., 246), a search result (e.g., 251), and trigger words that have been associated with a search query (e.g., 233a). Moreover, presentation capabilities (not depicted) of client 212 might also be provided to search-result-caption generator 218. In one embodiment, search-result-caption generator 218 includes an aggregator 290, which collects information 260 and 292 to be used by search-result-caption generator 218. Referring to FIG. 2b, which depicts search-result-caption generator 218 in more detail, data 281 includes information that has been collected by aggregator 290. Data 281 is depicted in exploded view 282 for illustrative purposes, and exploded view 282 illustrates that information from both searcher 214 and webpage-related-content compiler 216 might be utilized by search-result-caption generator 218 to synthesize search-result caption 224.

With continued reference to FIG. 2b, in a further embodiment, aggregator 290 communicates data 281 to a category ranker 284. Category ranker 284 determines a relevance of categories, which are listed under content-type categories 294, as each category relates to search query 243. Category ranker 284 might determine that based on user context 246, certain categories of content-type categories 294 are more relevant to search query 243 than others. For example, category ranker 284 might determine that when user context 246 is “product research,” “product id” 271 and “price” 273 are most relevant to search query 243. Such an exemplary embodiment is depicted by exploded view 287 in which “product id” has received a ranking of “1” and “price” has received a ranking of “2.” In an alternative example, if user context 246 included “person identification” then “Image” 283 and “social-network profiles” (not depicted) might be deemed by the ranker to be the most relevant.

In addition to considering user context, category ranker 284 might also take into consideration the actual text of a search query when determining category relevance. For example, if one search query included “read XL900 reviews” and an alternative search query included “buy XL900 online” the user context “product research” might be assigned to both search queries; however, category ranker 284 might assign “rating” 277 a higher relevance for “read XL900 reviews” and assign “price” 273 a higher rating for “buy XL900 online.” Moreover, where a confidence measure of user context has been provided by searcher 214 to search-result-caption generator 218, category ranker 284 might take the confidence measure into account when ranking each of the content-type categories.

In another embodiment, category ranker 284 communicates information 286 to caption designer 288, which functions to construct search-result caption 224. Information 286 is depicted in an exploded view 287 for illustrative purposes. Exploded view 287 depicts that information 286 includes information that has been classified into various categories, some of which have been ranked by category ranker 284. In addition to ranked content-type categories 291, exploded view also depicts search query 293a (e.g., “*price*laptop XL900” 293b) and user context 299a (e.g., product research 299b), all of which might be used by caption designer 288 to construct search-result caption 224.

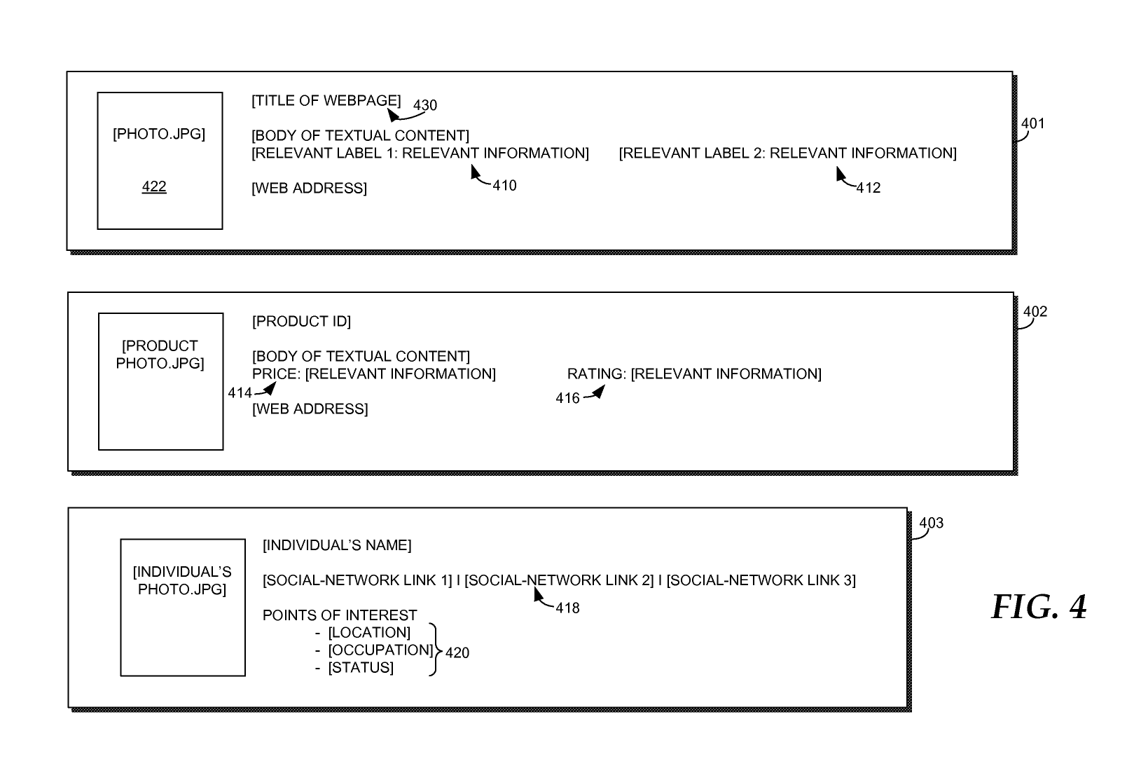

Upon receipt of data 286, caption designer 288 facilitates construction of search-result caption 224. In one embodiment of the present invention, caption designer 288 retrieves a caption template that is assigned to user context 299a. FIG. 4 depicts three exemplary caption templates 401, 402, and 403. Generally, caption templates 401, 402, and 403 include a prearranged set of information fields (e.g., 410, 412, and 418) that are populatable by caption designer 288. In one embodiment, caption templates are user-context specific, such that a caption template 402 for “product research” might include information fields (e.g., 414 and 416) that are arranged in a different configuration than information fields (e.g., 418 and 420) of caption template 403, which is customized for a person-identification caption. In a further embodiment, the caption template is selected by taking into consideration a variety of factors, such as the user context, an amount of the compilation of webpage-related content, capabilities of a client device, a quality of information included in the compilation of webpage-related content, or a combination thereof. For example, only a small amount of information is available, a template with fewer populatable fields might be selected. On the other hand, if a larger amount of information is available, a template with more populatable fields might be selected.

In a further embodiment, caption templates might include varying levels of populatable fields, such that caption designer 288 is afforded varying levels of control over caption content depending on the caption template that is retrieved. For example, both caption templates 401 and 402 might be selected to construct a caption relating to a product-research user context. However, caption template 401 includes information field 410, which is to be populated with relevant information, as well as a label that describes the relevant information. For example, when the relevant information includes an amount of RAM of a given product, the relevant-information label might include “product specification.” In contrast, caption template 402 is preconfigured to include a “price” label and a “rating” label, such that caption designer 288 might be limited to these categories of information when constructing a caption.

Caption designer 288 determines what information to use to populate information fields of a retrieved caption template, such as by taking into consideration the various factors that influence user context (e.g., user objective, trigger words, etc.). For example, if template 401 were retrieved to construct search-result caption 224, caption designer 288 determines what information to include in information fields 410, 412, and 422. Caption designer 288 might also customize a caption title 430. In one embodiment, the amount of information available to populate a caption template is equal to or less than the amount of information allowed to populate the caption template, such that all information available is used to populate. In an alternative embodiment, the amount of information available to populate a caption template is more than the amount allowed to populate the caption template, such that caption designer 288 evaluates information provided in data 286 to determine which information to include in search-result caption 224. For example, caption designer 288 might select information that is ranked highest (e.g., Product ID and Price) to be included in search-result caption 224. Furthermore, caption designer might recognize that image field 422 needs to be populated and automatically select image data 265. Moreover, caption designer 288 might recognize that “*price*” has been flagged as particularly relevant and format pricing information 263 to be presented in a more prominent manner (e.g., larger and/or colored font). In another embodiment, caption designer 288 might include product identification in title 430, thereby opening information field 412 to be populated with rating information 297. Referring to FIG. 3, search-result caption 312 depicts an exemplary caption that might have been constructed by caption designer 288. As depicted, information that was deemed particularly relevant to search-result caption 312 has been selected and populated at information fields 316 and 318. Moreover, pricing information depicted information field 318 is more prominently displayed.

In a further embodiment, search-result caption 224 is provided to client 212. For example, FIG. 2b depicts that information 211 is sent to client 212. Information 211 is shown in exploded view 213 for illustrative purposes and includes a web page that presents a set of search-result captions, each of which represents content of a respective webpage.

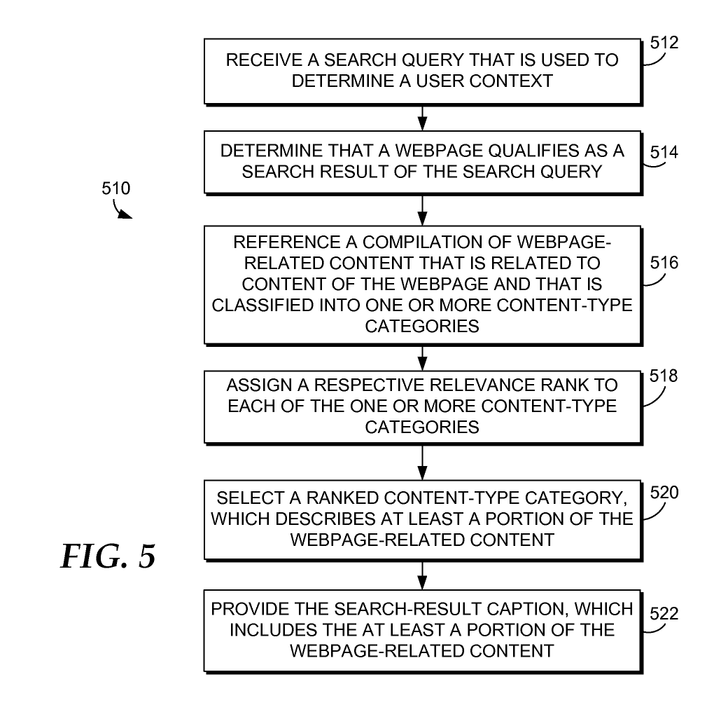

One embodiment of the present invention includes one or more computer-readable media having computer-executable instructions embodied thereon that, when executed, cause a computing device to perform a method of generating a search-result caption that summarizes content of a webpage. Referring to FIG. 5, in one embodiment, the method 510 includes receiving 512 a search query that is used to determine a user context and determining 514 that the webpage qualifies as a search result of the search query. The method 510 also includes referencing 516 a compilation of webpage-related content that is related to content of the webpage and that is classified into one or more content-type categories. At step 518 a respective relevance rank is assigned to each of the one or more content-type categories. The respective relevance rank suggests a measure of relevance of a respective content-type category to the user context. The method 510 also includes selecting 520 a ranked content-type category, which describes at least a portion of the webpage-related content, and providing 522 the search-result caption, which includes the at least a portion of the webpage-related content.

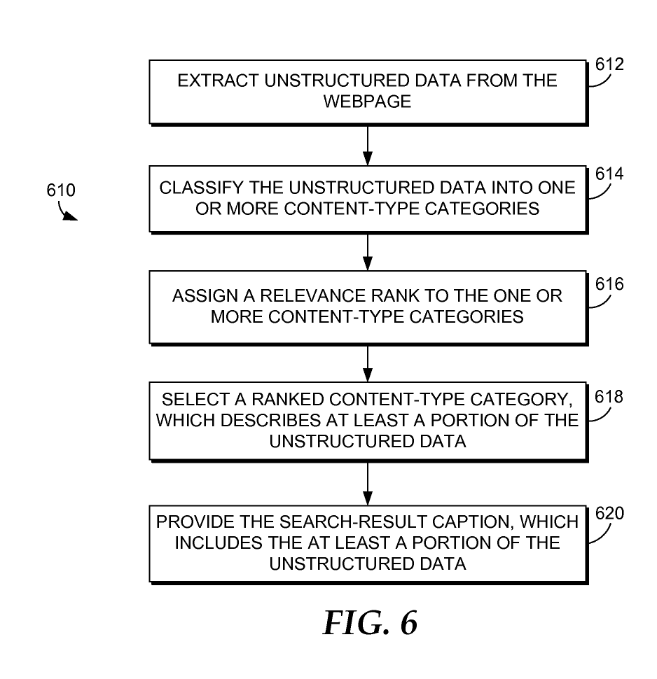

Referring to FIG. 6, another embodiment includes a method 610, which is executed by a processor and one or more computer-readable media, of generating a search-result caption that summarizes content of a webpage. Method 610 includes extracting 612 unstructured data from the webpage, and classifying 614 the unstructured data into one or more content-type categories. In addition, step 616 includes assigning a relevance rank to the one or more content-type categories. The relevance rank suggests a measure of relevance of the one or more content-type categories to a user context, which is inferred from a search query. Method 610 also includes selecting 618 a ranked content-type category, which describes at least a portion of the unstructured data. At step 620 the search-result caption is provided that includes the at least a portion of the unstructured data. In one embodiment, the search-result caption includes a label that describes the at least a portion of the unstructured data.

Another embodiment of the present invention includes a system, which includes a processor and one or more computer-readable media, that performs a method of generating a search-result caption that summarizes content of a webpage. The system includes an unstructured-data extractor 232 that extracts unstructured data from the webpage and an unstructured-data classifier 234 that categorizes the unstructured data into one or more content-type categories. The system also includes a search-query receiver 244 that receives a search query, wherein a user context is inferred from the search query. The webpage is deemed to be a search result of the search query. The system also includes a category ranker 284 that assigns to each of the one or more content-type categories a respective rank, which suggests a measure of relevance to the user context. Also included in the system is a caption designer 288 that selects a ranked content-type category, which describes at least a portion of the unstructured data, and that configures the search-result caption to include the at least a portion of the unstructured data.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer-readable media having computer-executable instructions embodied thereon that, when executed, cause a computing device to perform a method of constructing a search-result caption that represents content of a webpage, the method comprising:
receiving a search query that is used to determine a user context;
determining that the webpage qualifies as a search result of the search query;
referencing a compilation of webpage-related content that is related to content of the webpage and that is classified into one or more content-type categories;
assigning a respective relevance rank to each of the one or more content-type categories, wherein the respective relevance rank suggests a measure of relevance of a respective content-type category to the user context;
selecting a ranked content-type category, which describes at least a portion of the webpage-related content; and
providing the search-result caption, which includes the at least a portion of the webpage-related content.

2. The one or more computer-readable media of claim 1, wherein the user context suggests an objective of the user when submitting the search query.

3. The one or more computer-readable media of claim 1,
wherein the compilation of webpage-related content includes unstructured data extracted from the webpage, and
wherein the unstructured data is classified into the one or more content-type categories.

4. The one or more computer-readable media of claim 1,
wherein the compilation of webpage-related content includes unstructured data extracted from a second webpage of a website, which also includes the webpage, and
wherein the unstructured data is classified into the one or more content-type categories.

5. The one or more computer-readable media of claim 1,
wherein the compilation of webpage-related content includes unstructured data extracted from a third webpage of another website, which does not include the webpage, and
wherein the unstructured data is classified into the one or more content-type categories.

6. The one or more computer-readable media of claim 1,
wherein the compilation of webpage-related content includes structured data extracted from a third webpage of another website, which does not include the webpage, and
wherein the structured data is classified into the one or more content-type categories.

7. The one or more computer-readable media of claim 1,
wherein the compilation of webpage-related content includes structured data extracted from feeds data, and
wherein the structured data is classified into the one or more content-type categories.

8. The one or more computer-readable media of claim 1, wherein the user context is determined based on a user objective, a trigger word, a search history, a browsing history, a capability of a client device, a user demographic, an event, a time of day, a user objective, a user-specified preference, or a combination thereof.

9. The one or more computer-readable media of claim 1, wherein the method comprises:
populating a caption template, which is customized to present information that is relevant to the user context, wherein the caption template is selected based on the user context, an amount of the compilation of webpage-related content, capabilities of a client device, a quality of information included in the compilation of webpage-related content, or a combination thereof.

10. The one or more computer-readable media of claim 9, wherein the caption template includes a first information field, which is populated with text that generically represents content of the webpage, and wherein the caption template includes a second information field that is populated with the at least a portion of the webpage-related content.

11. The one or more computer-readable media of claim 1, wherein the at least a portion of the webpage-related content is configured to be prominently displayed.

12. A method, which is executed by a processor and one or more computer-readable media, of generating a search-result caption that summarizes content of a webpage, the method comprising:
extracting unstructured data from the webpage;
classifying the unstructured data into one or more content-type categories;
assigning a relevance rank to the one or more content-type categories, wherein the relevance rank suggests a measure of relevance of the one or more content-type categories to a user context, which is inferred from a search query;
selecting a ranked content-type category, which describes at least a portion of the unstructured data; and
providing the search-result caption, which includes the at least a portion of the unstructured data, wherein the search-result caption includes a label that describes the at least a portion of the unstructured data.

13. The method of claim 12 further comprising, extracting webpage-related content from another webpage, which shares a common website with the webpage,
wherein the webpage-related content includes structured data of the other webpage, unstructured data of the other webpage, or a combination thereof, and
wherein the search-result caption includes the structured data of the other webpage, the unstructured data of the other webpage, or the combination thereof.

14. The method of claim 12 further comprising, extracting webpage-related content from another webpage, which does not share a common website with the webpage,
wherein the webpage-related content includes structured data of the other webpage, unstructured data of the other webpage, or a combination thereof, and
wherein the search-result caption includes the structured data of the other webpage, the unstructured data of the other webpage, or the combination thereof.

15. The method of claim 12 further comprising, extracting webpage-related content from another webpage, which does not share a common website with the webpage,
wherein the webpage-related content includes structured feeds data of the other webpage, and
wherein the search-result caption includes the structured feeds data of the other webpage.

16. The method of claim 12, wherein assigning the relevance rank comprises weighing a combination of factors, which include the measure of relevance, in addition to a first quality score that suggests a quality level of the unstructured data, a second quality score that suggests a quality level of any structured data that was extracted, a confidence score that suggests a degree to which the user context is deemed to be accurate, or a combination thereof.

17. A system, which includes a processor and one or more computer-readable media, that performs a method of generating a search-result caption that summarizes content of a webpage, the system comprising:
an unstructured-data extractor that extracts unstructured data from the webpage;
an unstructured-data classifier that categorizes the unstructured data into one or more content-type categories;
a search-query receiver that receives a search query,
wherein a user context is inferred from the search query, and
wherein the webpage is deemed to be a search result of the search query;
a category ranker that assigns to each of the one or more content-type categories a respective rank, which suggests a measure of relevance to the user context; and
a caption designer,
wherein the caption designer selects a ranked content-type category, which describes at least a portion of the unstructured data, and
wherein the caption designer configures the search-result caption to include the at least a portion of the unstructured data.

18. The system of claim 17, wherein the unstructured-data extractor extracts unstructured data from another webpage, which shares a common website with the webpage.

19. The system of claim 17 further comprising, a structured-data extractor, which extracts structured data from other webpages, and a structured-data classifier, which categorizes the structured data into one or more content-type categories.

20. The system of claim 17, wherein the unstructured-data extractor and unstructured-data classifier include a customized crawler that classifies extracted unstructured data based on a similarity to already identified unstructured data.
